(19) United States
(12) Patent Application Publication
(10) Pub. No.: US 2005/0030971 A1
(43) Pub. Date: Feb. 10, 2005

(54) Adaptive bandwidth allocation over a heterogeneous system interconnect delivering true bandwidth-on-demand

(75) Inventor: John Yuan, Austin, TX (US)

Correspondence Address: Raffi Gostanian, Jr.;RG&Associates, 1103 Twin Creeks Drive, Allen, TX, 75013, US

(73) Assignee: VisionFlow, Inc., Austin, TX (US)

(21) Appl. No.: 10/913,570

(22) Filed: Aug. 6, 2004

Related U.S. Application Data
(60) Provisional application No. 60/493,509, filed on Aug. 8, 2003.
(60) Provisional application No. 60/499,223, filed on Aug. 29, 2003.

(51) Int. Cl. H04Q 11/00

(52) U.S. Cl. 370/462

(57) ABSTRACT

A scheduling system comprises at least one bus master, an isochronous channel designation and usage module, a priority scheme for random users module, a bus/bridge operation status module, and a scheduler operably coupled to the at least one bus master and to the modules.

### CROSS REFERENCE TO RELATED APPLICATIONS

The present patent application claims the benefit of commonly assigned U.S. Provisional Patent Application No. 60/493,509, filed on Aug. 8, 2003, entitled BANDWIDTH-ON-DEMAND: ADAPTIVE BANDWIDTH ALLOCATION OVER HETEROGENEOUS SYSTEM INTERCONNECT, and is related to commonly assigned U.S. Provisional Patent Application No. 60/499,223, filed on Aug. 29, 2003, entitled DESIGN PARTITION BETWEEN SOFTWARE AND HARDWARE FOR MULTI-STANDARD VIDEO DECODE AND ENCODE and to U.S. Patent Application Docket No. VisionFlow.00001, entitled SOFTWARE AND HARDWARE PARTITIONING FOR MULTI-STANDARD VIDEO COMPRESSION AND DECOMPRESSION, filed on even date herewith, the teachings of which are incorporated by reference herein.

### BACKGROUND OF THE INVENTION

The present invention is generally related to a method and system for performing adaptive bandwidth allocation over a heterogeneous system interconnect, thereby delivering true bandwidth-on-demand. Performing an effective set of communications between on-chip system components is the key to a high-performance System-on-a-Chip (SoC) design, especially when the design involves a data-intensive processing like video compression. SoC components such as processors, IP (Intellectual Property) solutions, memory/storage, and system peripheral functions come from various sources and may have problems in communicating with each other. It is essential for a successful SoC design to have a method or a system that facilitates effective communications between “domestic” and “foreign” system components. The method therefore enhances design re-use and shortens design cycle. Actually there are more challenges than a simple, physical integration to achieve desired system functionality. In past years many SoC products failed to deliver the expected system performance because of their ignorance for improving the overall system throughput. To improve the overall system throughput, a better system bandwidth allocation scheme is required. The effective inter-component communications require both efficient bandwidth allocation and effortless component plug-in.

The fundamental goal of “socketization,” as the industry defines it, is to specify a set of guidelines for preparing any given functional block for reuse. However, there are several flaws with current core-based reuse strategies. First, the proposed socket standards address only simple data flows. As a result, the designer must deal with the remaining inter-core communications requirements-control flows (such as interrupts, error signals and flow-control signals) and test signals (for debug and manufacturing test)-by hand-wiring them in an ad hoc fashion. Clearly, those socket standards were developed with the expectation that computer-style buses would continue to serve as the predominant on-chip interconnect fabric. But while computer buses are great for low-performance or computer-centric processing, they have hard time meeting the real-time requirement for data flows, control flows and test signals and leave it as an “exercise for the reader.”

Designers must build point-to-point links or other custom interconnect structures outside of the computer bus. However, since they cannot predict the final form and nature of those ad hoc inter-block communication schemes, system architects cannot accurately model them early in the design process. That unpredictability inevitably results in multiple design iterations, because the SoC rarely meets the product requirements as initially architected.

Another significant flaw in core-based reuse strategies is that they do not address the larger issues of core integration, such as frequency decoupling, system address map, interface timing and real-time throughput guarantees. As a result, the core design often becomes burdened with detailed system-level dependencies, particularly characteristics of other cores of the present system. This process tightly couples each core's functional behavior to that specific SoC implementation, severely hampering its reusability.

In other words, unless the core design and socketization process is informed by an effective chip integration strategy that decouples the core's functional behavior from inter-core communications requirements, the socketization process may actually inhibit rather than enhance design reuse, predictability and complexity management.

In addition to these issues, it is critical to allocate bandwidth as needed. Most current subsystem transmission schemes do not successfully calculate bandwidth needed for the given transmission from one system block to another. These applications simply place the data packets on the transmission media and rely on the protocol to handle the transmission or receipt of the given packet regardless of it size or internal make-up. Several problems rise out of the lack of bandwidth allocation. These can include “hogging” the pipe which reduces the capabilities and increases the transmit time for other applications on the same pipe, or delivering staggered, hung, or out-of-sync results at the receiving location.

Therefore, what is needed is a method and system for handling the issues around providing a uniform system interconnection platform as well as providing adaptive bandwidth allocation for the transmission of immensely long data streams within the subsystem architecture for efficiently handling both system and media processing requests. The present invention addresses both of these issues through the use of a method for adaptive bandwidth allocation over a heterogeneous system interconnect for delivering true bandwidth-on-demand.

### SUMMARY OF THE INVENTION

The present invention is aimed for solving the most critical system performance problem due to access contention of common memory devices and other shared system resources, especially for applications that require both media processing and networking support. Emerging applications like video broadcast over IP networks (wired or wireless), HDTV, HD-DVD, or networked camera recording, require a support for different video standards and networking protocols in spite of continuous evolution of the standards and protocols. DVD-Forum has mandated that the next generation DVD (HD-DVD or high definition DVD) support three different video formats: H.264, VC-9, and MPEG-2. Worldwide digital TV broadcasters have been promoting H.264 along with the legacy MPEG-2 video for both HDTV broadcast and mobile-TV broadcast.

For system applications that involve video processing, a multi-standard video solution that supports both emerging and legacy video applications becomes essential. Unfortunately current silicon products, regardless they are based on a programmable architecture (e. g. media processor) or a hardwired ASIC architecture, run out of steam when the multi-standard video processing or high-definition video processing is required. The SoC designs emerged in past years are striving to combine strengths of programmable and hardwired architectures by integrating programmable processors (RISC and/or DSP) and hardware IP (Intellectual Property) blocks into a single-chip design, but failed to deliver performance and functionality as promised. It takes a system solution rather than a simple physical integration to make a SoC design work for these demanding applications. One of major problems with the previous approaches is the lacking of effective communications among various on-chip system components (processors, memory subsystem, special hardware functions, and/or system peripheral functions). The effective communications take place only if there is sufficient system bandwidth for transferring data and executing tasks required by a chosen application.

The system components within a SoC can be divided into five groups: (1) Programmable processors, such as RISC processors or DSP's, (2) special-function hardware, such as video compression engine, network protocol engine, etc., (3) high-speed connectivity/interface, such as 10/100/1000 BASET-T Ethernet, PCI, ATAPI/IDE, (4) low-speed system peripheral device, such as timers, UART, etc., and (5) control/interface to internal/external storage devices, such as DRAM, Flash, SRAM, ROM, etc. Among them, the group (5) is the most commonly shared system resources by either a processor or a hardware design. To take advantage of programmability offered by a processor and predictable performance by a hardware design, system or application functions can be re-partitioned between software and hardware. Therefore increasing interactions between a processor and any hardware can be expected with this approach. A traditional shared bus design proves to be insufficient for heavy data transfer. A heterogeneous interconnect that mixes a cross-bar architecture and a shared bus architecture is required for improving the system throughput. The cross-bar bus is mainly used for data communication channels between system components that involves heavy data transfer, for example, data transfer between a video engine and a memory subsystem. It is for data flow processing. The shared bus is mainly used for control or less demanding data transfer between system components. It provides a separate path for control flow processing.

A majority of system components share system resources and communication channels to a certain degree and contention over these resources/channels can not be avoided. Scheduling and arbitration mechanisms must be developed for accessing the resources and/or channels. This determines how effective and efficient the system components are at communicating with one another. The solution of these problems is based on this scheduling and arbitration strategy. The primary goals of the strategy are to create a configurable, on-chip communication system that supports all data, control, test and debug flows; to deliver hardware-assisted guaranteed bandwidth allocation to each core (system module with processing capabilities); to decouple core-to-system communications from core functionality; to provide a methodology for creating truly “componentized” cores with sufficient design independence to be reused without rework; and to simplify, speed and make more predictable the design, analysis, verification, debugging and testing of multi-core designs.

The power of this integration strategy to enable true core reusability hinges on two essential elements: an interface protocol that encompasses all communication flows into and from the core, and an integration methodology that effectively decouples system-level requirements from core functionality.

The first step in the strategy is to incorporate a comprehensive, standard interface protocol within the core that facilitates communication between cores. As with any socket standard, the protocol must be core-centric rather than system-interconnect-centric. In other words, if the core is to remain untouched as it moves from system to system, its interface must accommodate the unchanging requirements of the core rather than bend to the particular requirements of each system in which it is deployed.

The next step in the communication system-based integration strategy is to implement a highly reconfigurable on-chip communication subsystem-a sort of customizable backplane in silicon-that implements the system-level requirements of the SoC. It must support traditional CPU-memory accesses, high-bandwidth links with real-time throughput requirements, as well as lower-speed peripherals. The backplane serves to unify all on-chip communications while providing configurable throughput guarantees to individual cores. As such, the backplane can replace dedicated connections between cores with logical connections over shared interconnect, while simultaneously supporting low-latency access from high-performance CPUs.

Each core connects to the backplane through an “agent”-the key to decoupling the cores. Agents implement a system-level communications protocol on top of the actual physical interconnect scheme. Each agent is highly customized to meet the system-level communications requirements of the core to which it is mated (for example, data width, address size and clock frequency).

The agent also provides for efficient utilization of system bandwidth and implements the system-address map, frequency decoupling, control-flow routing and real-time performance guarantees in terms of latency and bandwidth.

A significant side benefit of the communication system-based integration strategy is that it localizes all of the long, intercore wires within the backplane. That allows the designer to identify the long wires early in the design and to optimize them without affecting core interface timing. The backplane must be configurable to ensure allocation of sufficient bandwidth for all communication flows inside the SoC. The present invention provides for a configurable subsystem which eliminates the need for expensive speed-matching FIFO resources at each core's interface by treating the shared interconnect as a communication system. Instead of relying on consecutive cycle bursts to increase transfer efficiency, the present invention interleaves data transfers from different backplane agents on a per-cycle basis.

Coupled with the need to have subsystem components communicating efficiently, the system architecture must address the process of allocating communication bandwidth as needed. Unfortunately, the allocation varies from application to application. Often, it is more efficient, especially when transmitting a long stream of data, to allocate bandwidth for several short packets instead of one long packet.

The adaptive bandwidth allocation of the present invention, called bandwidth-on-demand, is designed to dynamically allocate the channel bandwidth in response to real time processing requirements determined by the application of interest. The scheme developed adopts a hybrid approach that mixes the static and dynamic scheduling functions. The schedule can be set in a static manner during configuration and can be modified during run time.

This hybrid scheme divides system events into two types of timing windows: isochronous and random. Regarding figure FIG. 1, the schedule allocates isochronous windows for both video and audio processing because of their critical timing requirements. Spaces between the isochronous windows are open for random system events. These are all available in an asynchronous fashion.

Regarding FIG. 2, the isochronous windows can be re-allocated for random system events if they are not being used.

Regarding FIG. 3, the isochronous windows can be modified if only part of them are needed to be changed for system event usage. This allows for an increase in system response activity while still providing process bandwidth to the audio and/or video being processed using the isochronous windows.

In order to realize the adaptive bandwidth allocation scheme of the present invention into the SoC design, the essential tasks can be described hierarchically in a layer structure, as shown in FIG. 4.

The initial component of this layered structure is defined as Layer 0. Layer 0, or task characterization, determines the nature of the processing tasks in the system architecture. These include periodical, random or conditional periodical. The periodical processing task includes repetitive events that require a nearly fixed amount of processing bandwidth. The random processing task includes events triggered through interrupts, exceptions, or other random system events. An arbitration scheme is chosen initially to resole any conflict in the case there is a contention. Thirdly, the conditionally periodical processing task includes events commonly seen in the media and communication processing area where the periodical behavior starts when a given condition is met.

The second component of this layered structure is defined as Layer 1. Layer 1, or initial schedule and priority, schedules for periodical and/or timing critical events, and a priority scheme (including round robins, fixed, 2-bit random, etc.) for random events. They are typically defined during the initial configuration and can be adjusted at run time.

The third and final component of this layered architecture is Layer 2, schedule/priority adaptation. This layer deals with scheduling (bandwidth allocation) given processing tasks. The timing of these processing tasks can be modified according to the need in real time processing. The allocated windows can be re-allocated for other usage or modified for partial usage (FIG. 3). This mechanism for adaptation is extremely useful in reducing the idle states for unused system resources.

Layer 0 processing identifies the nature of the incoming tasks and system resources involved. It also makes high-level decisions in scheduling downstream tasks by categorizing them into periodical, conditionally periodical, and random tasks. It typically assigns time-critical processes such as those involved in audio or video processing functions to isochronous windows, e.g. conditionally periodical or periodical processing windows. Each isochronous window is typically associated with a bus/network initiator (or driver), a system component that initiates or drives the bus/network, e.g. a RISC processor, pixel reconstruction unit, DMA, etc.

Layer 1 processing follows the decision made in the Layer 0, and loads the desired scheduling information into the hardware scheduler that consists of RAM or programming registers. At this stage, the scheduling is done in a static fashion, as described in FIG. 1 by assigning needed isochronous windows in a pre-defined period of time. This is typically performed during the initial system configuration, The scheduler allocates bandwidth initially until it is modified at run time when the Layer 2 processing takes over.

The Layer 2 processing performs dynamic scheduling by examining the requested usage patterns from the initiators and decides whether to modify the allocated bandwidth during the system configuration or not. The block diagram in FIG. 4 describes this in an overview fashion.

Regarding FIG. 5 and FIG. 6, three bus masters (initiators) A, B, and C are requesting the access. The scheduler examines the requested usage pattern from each of them and decides whether to change the initial schedule. The usage pattern typically has the information about how much data is to be transferred and for how long. The key is to have the usage pattern information sent along with the bus request. For these initiators who are assigned to a random window, they have to compete with other random initiators according to the pre-set priority scheme. The priority scheme can be modified as well if the previously chosen one can not satisfy the system given requirement.

An interface wrapper is responsible for interfacing with system components that have a foreign communication protocol. The wrapper consists of a bridge function and a temporary storage buffer. The bridge extracts source, destination, and control/data streams from the foreign components and sends them over to the switch fabric if the switch fabric is ready to receive. Otherwise, the bridge sends the data to the buffer to wait on the switch fabric.

The switch fabric is responsible for routing control/data streams to the proper destination when the given channel is available. Then the scheduler controls the channel allocation for each requested transaction. It plays a crucial role in handling system resource contentions.

FIG. 7 describes an example implementation showing the interconnect based on a cross-bar switch network where the bus traffic can flow in a two dimensional array-like bus structure.

The example described in FIG. 8 shows the interconnect based on a single bus shared by all system modules attached to it.

The block diagram in FIG. 9 shows the design logic of a wrapper/buffer structure which supports the interface wrapper for foreign communication protocols.

In summary, the present invention provides a flexible, effective and efficient interconnect mechanism that improves on-chip system communication through adaptively modulating the system and processing needs through bandwidth control settings. This mechanism is an adaptive bandwidth allocation scheme, based on a heterogeneous system interconnect. The interconnect can be a shared bus, a cross-bar network, or a hybrid of the two.

The three key ideas that make the given adaptive bandwidth allocation scheme of the present invention useful include: (1.) a hybrid scheduling technique for bus events by mixing fixed and dynamic scheduling schemes based on a three-layer task scheduling strategy. Within this strategy, a fixed priority bus schedule can initially be define by software running in a processor, and can be modified dynamically by assisting hardware during run time. (2.) hardware design that makes the adaptive bandwidth allocation feasible during run time, and (3.) wrapper/buffer hardware design that allows system modules from different sources to communicate with each other through a cross-bar network.

### BRIEF DESCRIPTION OF THE DRAWINGS

FIG. 1 shows an adaptive bus/memory bandwidth allocation example utilizing isochronous windows in time to set the expiration times for the video and audio objects;

FIG. 2 shows an adaptive bus/memory bandwidth allocation example utilizing isochronous windows in time to reallocate full segments of unused audio and video blocks (these objects have expired due to their lack of usefulness within the given window of time);

FIG. 3 shows an adaptive bus/memory bandwidth allocation example utilizing isochronous windows in time to reallocate portions of unused or expired audio and/or video blocks;

FIG. 4 shows a multi-layered process which examines packet contents and performs dynamic scheduling;

FIG. 5 shows a scheduler which examines the data contents to handle process scheduling;

FIG. 6 shows a low-level overview the scheduler process where usage pattern id and request master id are passed to the scheduler and a grant id is transmitted as a response;

FIG. 7 is an architectural implementation example showing the use of a heterogeneous interconnect using a cross-bar;

FIG. 8 is an architectural implementation example showing the use of a heterogeneous interconnect using a shared bus; and

FIG. 9 shows the wrapper and buffer detail and its use with the system interconnect.

### DETAILED DESCRIPTION OF THE INVENTION

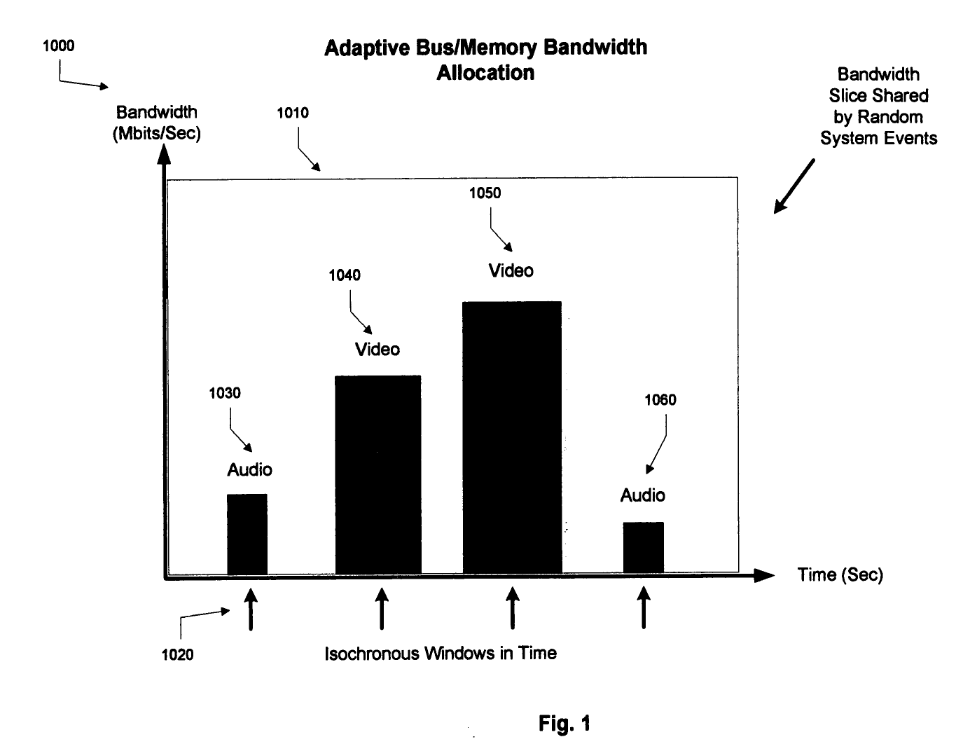

Referring to FIG. 1, the system 1000 of the present invention shows a bandwidth slice 1010 which encapsulates an audio stream packet 1030, another audio stream packet 1060, a video stream packet 1040 and another video stream packet 1050. The packets 1030, 1040, 1050, and 1060 occupy varying bandwidth windows within a given period of time. These packets are further encapsulated by a first isochronous window, another isochronous window and a final isochronous window. This encapsulation protects the priority and bandwidth allocation of the given packet. The time outside these windows are open for any random system event to use. Random system events are un-protected within the isochronous encapsulations and they only use available time slots outside the windows.

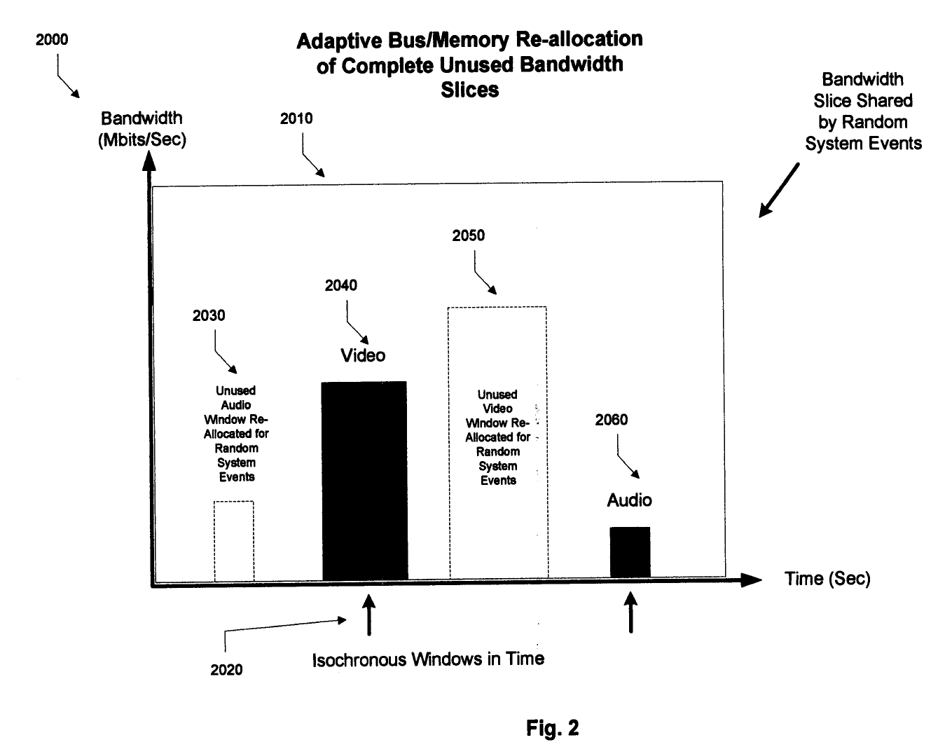

Referring now to FIG. 2, the system 2000 of the present invention includes a bandwidth slice 2010 which encapsulates an audio stream packet 2030, another audio stream packet 2060, a video stream packet 2040 and another video stream packet 2050. The packets 2030, 2040, 2050, and 2060 occupy varying bandwidth windows within a given period of time. These packets are further encapsulated by a first isochronous window, another isochronous window and a final isochronous window. This encapsulation protects the priority and bandwidth allocation of the given packet. Here, the process scheduler which allocated the bandwidth previously, has now determined that the audio stream packet 2030 and the video stream packet 2050 will not use the allocated bandwidth in their encapsulated windows. These windows are then open up for random system processes.

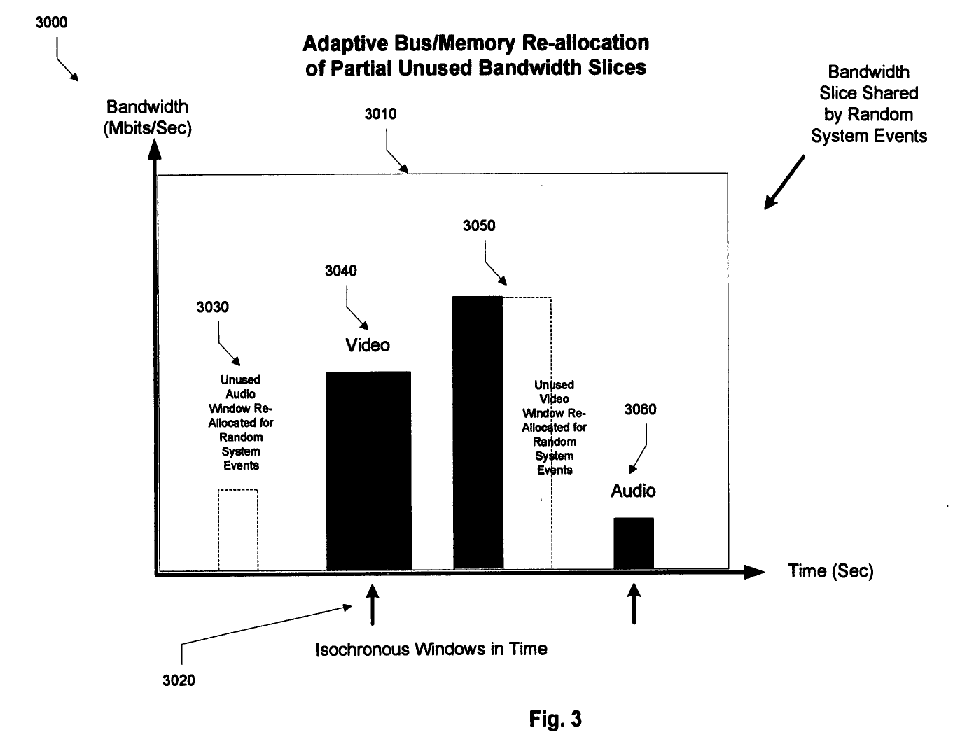

Referring now to FIG. 3, the system 3000 of the present invention includes a bandwidth slice 3010 which encapsulates an audio stream packet 3030, another audio stream packet 3060, a video stream packet 3040 and another video stream packet 3050. The packets 3030, 3040, 3050, and 3060 occupy varying bandwidth windows within a given period of time. These packets are further encapsulated by a first isochronous window, another isochronous window and a final isochronous window. This encapsulation protects the priority and bandwidth allocation of the given packet. Here, the process scheduler which allocated the bandwidth previously, has now determined that the audio stream packet 3030 will not use its allocated bandwidth at all and the video stream packet 3050 partially use its allocated bandwidth, thereby allowing unused portions of the allocated bandwidth to be made available to random system event processes.

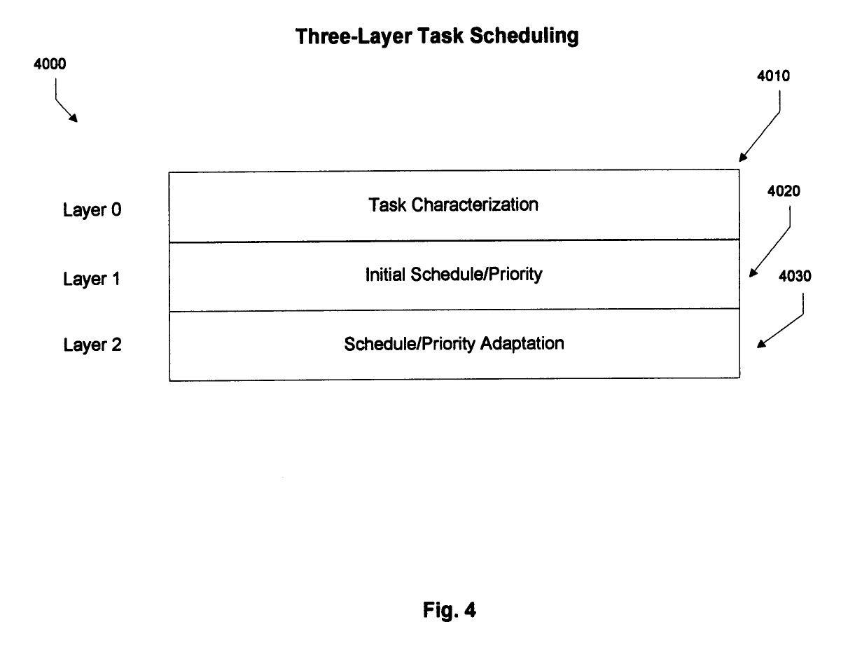

Referring now to FIG. 4, the system 4000 of the present invention describes the use of three layers of the scheduler process. Initially, Layer 0 4010 receives a task identifier. The Layer 0 4010 identifies the nature of the incoming task and makes a high-level decision in scheduling downstream tasks. It is here that a time-critical tasks may be assigned its own isochronous window and while other downstream tasks may be re-assigned. Once the Layer 0 decision has been made, the Layer 1 4020 loads the desired scheduling information into the hardware infrastructure. At this point, the information from Layer 1 is passed to the Layer 2 process scheduling module 4030 which then examines the requested usage patterns and decides whether the allocated bandwidth needs to be modified or not.

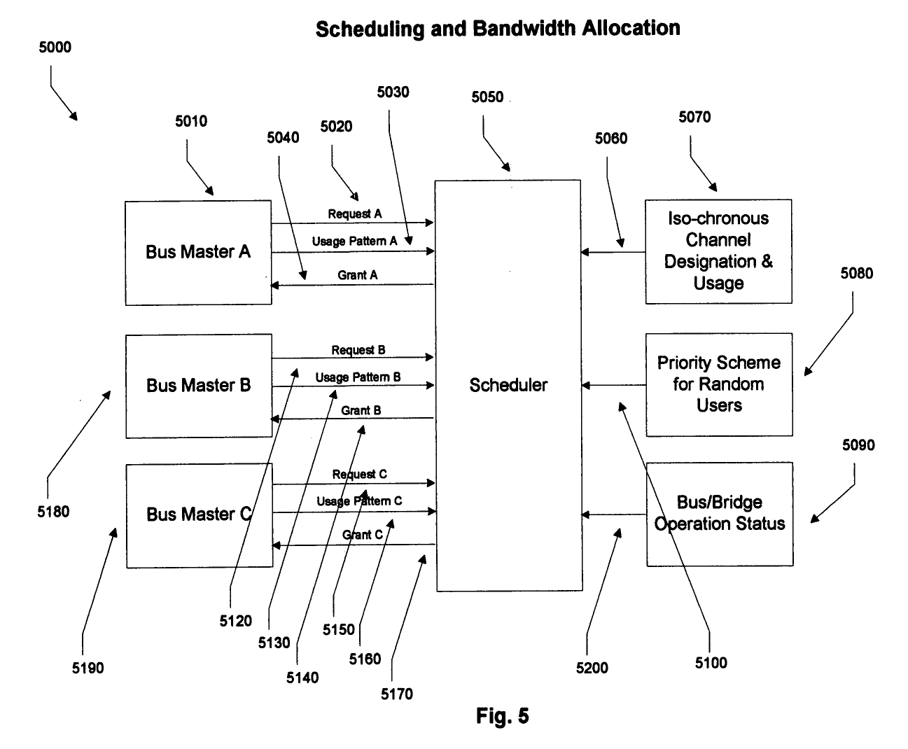

Referring now to FIG. 5, the system 5000 of the present invention describes the use of the scheduler in obtaining process prioritization and process grant to access certain system resources, such as system memories, and/or interface devices. This example contains three bus masters, A, B and C, 5010, 5180 and 5190, respectively. Bus master A transmits a request A 5020 and a usage pattern A 5030 to a scheduler 5050 which reads current channel/bandwidth usage policy for isochronous events 5060, priority scheme for random events 5100 and status of bus/system resource 5200 from module 5070, module 5080, and module 5090, respectively. The isochronous channel designation and usage module 5070 transmits a first identifier 5060 which provides information to a scheduler 5050 regarding bandwidth allocations for current isochronous processes within the given process time window. This is basically a list of processes which are in the queue, how long they will be in the queue and the amount of resources they are taking up. The scheduler 5050 also receives a second identifier 5100 regarding the priority and status of possible random processes. In addition, the scheduler 5050 receives the identifier 5200 regarding the overall bus/bridge status. This provides information regarding availability of bus/system resources. A scheduler 5050 also considers additional requests and usage patterns 5120, 5130 and 5150, 5160 to determine which request be granted now or later. Once the grant identifier(s) are prepared, they are transmitted to the chosen bus master.

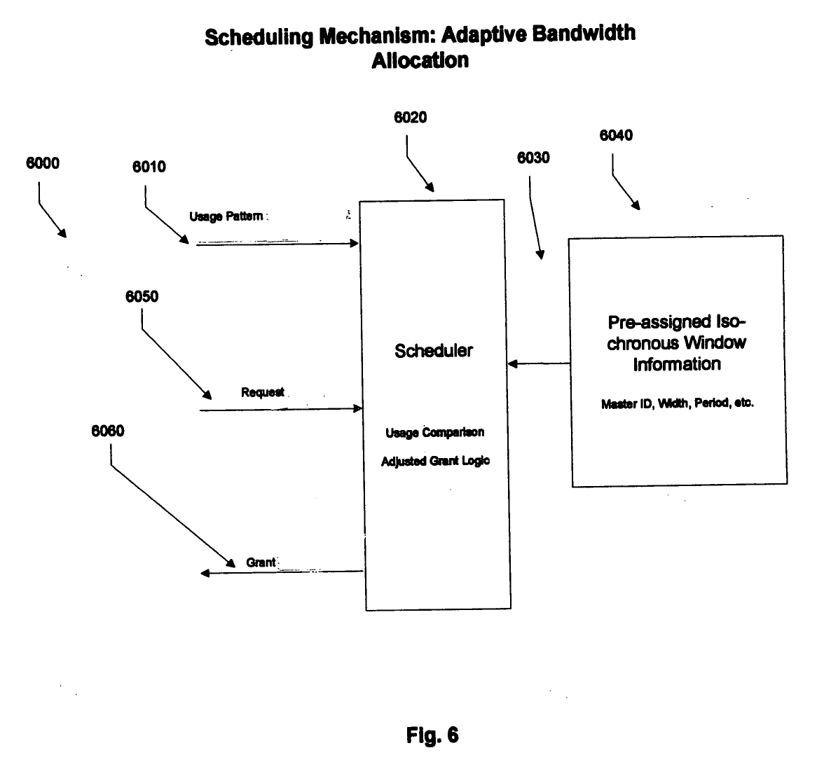

Referring now to FIG. 6, the system 6000 of the present invention further describes the use of the scheduler in obtaining process prioritization and process grant identifiers. Here, the scheduler 6020 receives a usage pattern and a master id 6010 which contains information regarding a size of data packets and the number of packets that the bus master wishes to transmit on the system interconnect. The scheduler 6020 also receives a request master identifier 6050 which contains a reference identifier. Once the requests 6010 and 6050 are received by the scheduler 6020, the scheduler queries the module 6040 for isochronous window information from module 6040. The scheduler 6020 receives the isochronous window information 6030 from the module 6040 and begins a comparison process. The scheduler then adjusts its grant logic for the incoming bus request 6010 as well as previous bus allocations and transmits a grant signal through response 6060 to the chosen bus master.

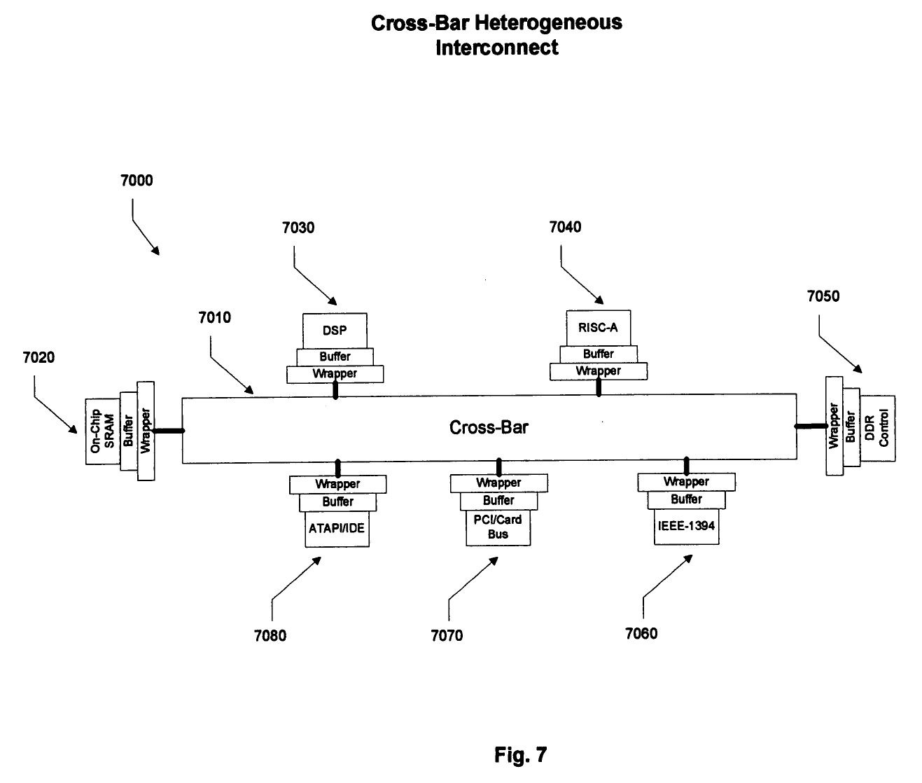

Referring now to FIG. 7, the system 7000 of the present invention further describes the use of the system interconnect using a cross-bar 7010. The cross-bar has a first bus master 7030 and another bus master 7040 attached to it. Also there are attached modules 7080, 7070, 7060 that can be either a bus master or a bus slave. The two slave-only modules are the on-chip SRAM 7020 and the DDR control 7050. Both bus master and master/slave are utilized within the system architecture as two-way communication modules which have the ability to both transmit and receive control process requests as well as data. For example, the bus master 7060 has the ability to open its port through a process command as well as receive and/or transmit digital data packets to/from an outside source. Each bus master or master/slave module contains a buffer and a wrapper which is used to simplify and uniform the communication protocols between the bus module and the communication channel.

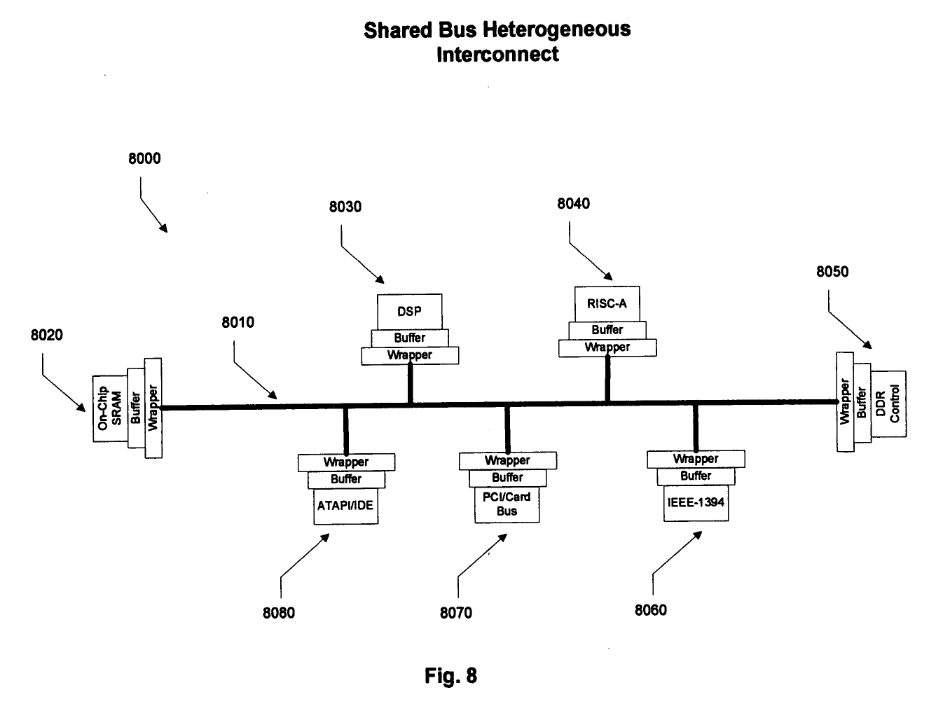

Referring now to FIG. 8, the system 8000 of the present invention further describes the use of the system interconnect using a shared bus 8010. Each bus master or master/slave module contains a buffer and a wrapper which is used to simplify and uniform the communication protocols between the bus module and the communication channel. The main difference between the shared bus and cross-bar architecture has to do with the ability to provide multi-channel communications over the same bridge. The shared bus is just that—the bus is time shared across each of the bus masters.

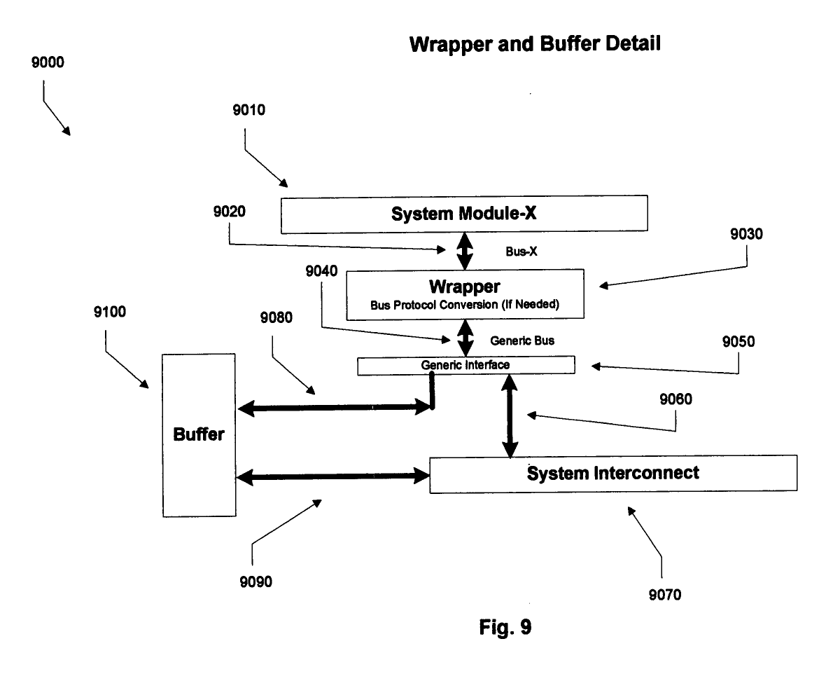

Referring lastly to FIG. 9, the system 9000 of the present invention further describes the details of the buffer master which contains a system module 9010, a wrapper 9030, a generic interface 9050, a buffer 9100, and a connection to the system interconnect 9060 and/or 9090. Utilization of the wrapper 9030 maintains uniformity in the communication protocol layer so that multiple system modules have the ability to communicate with each other even though their protocols are different (heterogeneous).

In order to begin communication with the system interconnect 9070, the system module 9010 must transmit a request 9020 to the wrapper 9030. The wrapper 9030 receives the request 9020 and performs a protocol conversion if necessary. The wrapper 9030 converts the protocol and transmits the command and data 9040 to the generic bus 9050. If the wrapper 9030 does not require any protocol conversion, it transmits 9040 directly to the generic interface 9050. If a system interconnect 9070 is then ready to receive new command/data, the generic interface 9050 transmits the command 9060 to the system interconnect 9070. If the system interconnect 9070 is busy and not able to receive a new command, the command 9080 is transmitted from the generic bus 9050 to the buffer 9100 and held until the system interconnect 9070 is available. Once the system interconnect 9070 is available to process additional requests, the buffer transmits the command/data 9090 to the system interconnect 9070 for processing.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A scheduling system, comprising:
at least one bus master;
an isochronous channel designation and usage module;
a priority scheme for random users module;
a bus/bridge operation status module; and
a scheduler operably coupled to the at least one bus master and to the modules.

2. The system of claim 1, wherein the bus master is adapted to transmit a request and a usage pattern to the scheduler.

3. The system of claim 2, wherein the scheduler reads current channel/bandwidth usage policy for isochronous events from the isochronous channel designation and usage module.

4. The system of claim 2, wherein the scheduler reads a priority scheme for random events from the priority scheme for random users module.

5. The system of claim 2, wherein the scheduler reads a status of a bus/system resource from the bus/bridge operation status module.

6. The system of claim 1, wherein the isochronous channel designation and usage module transmits a first identifier which provides information to a scheduler regarding bandwidth allocations for current isochronous processes within a given process time window.

7. The system of claim 6, wherein the information includes processes which are in a queue, how long they will be in the queue, and an amount of resources they are utilizing.

8. The system of claim 1, wherein the priority scheme for random users module transmits a second identifier which provides information to a scheduler regarding a priority and a status of possible random processes.

9. The system of claim 1, wherein the bus/bridge operation status module transmits a third identifier which provides information to a scheduler regarding an overall bus/bridge status.

10. The system of claim 9, wherein the bridge status provides an availability of bus/system resources.

11. The system of claim 1, wherein a plurality of bus masters is adapted to transmit a plurality of requests and usage patterns to the scheduler.

12. The system of claim 11, wherein the scheduler determines which requests to be granted and a time frame in which they are to be granted.

13. The system of claim 12, wherein the scheduler transmits the granted request to a respective bus master.

14. A method for adaptive bandwidth allocation, comprising:
receiving a usage pattern and a master id containing information regarding a size of data packets and a number of packets to be transmitted;
receiving a request master identifier containing a reference identifier;
receiving isochronous window information; and
transmitting a grant signal based on the received information.

15. The method of claim 14 comprising, after the receiving, adjusting grant logic for an incoming bus request and for previous bus allocations.

16. The method of claim 15 comprising transmitting a grant signal based on the adjusted grant logic.

17. The method of claim 16 comprising receiving the transmitted signal by a chosen bus master.

18. A computer readable medium comprising instructions for:
receiving a request by a wrapper from a system module;
receiving a command and data by a generic bus from the wrapper if a protocol conversion is performed by the wrapper;
receiving the command at a system interconnect if the system interconnect is ready to receive new commands and data; and
receiving the command and the data by the system interconnect for processing.

19. The computer readable medium of claim 18 comprising receiving a command and data by a generic interface from the wrapper if a protocol conversion is not performed by the wrapper.

20. The computer readable medium of claim 18 comprising receiving the command at a buffer from the generic bus if the system interconnect is not able to receive a new command.

21. The computer readable medium of claim 18, wherein the protocol conversion is based on the received request.

22. The computer readable medium of comer claim 18 comprising holding the command until the system interconnect is able to receive a new command.

23. A computer readable medium comprising instructions for:
receiving a request by a first module from a second module;
receiving a command and data by a generic bus from the first module if a protocol conversion is performed by the first module;
receiving the command at a third module if the third module is ready to receive new commands and data; and
receiving the command and the data by the third module for processing.
